(19) United States
(12) Patent Application Publication
(10) Pub. No.: US 2008/0017473 A1
(43) Pub. Date: Jan. 24, 2008

(54) Removable Hinged Cashbox

(76) Inventors: Michael D. Nunn, West Chester, PA (US); Evan J. Cost, Audubon, PA (US); Peter Bullard, Schwenksville, PA (US); Thomas E. Shuren, West Chester, PA (US)

Correspondence Address: FISH & RICHARDSON P.C., P.O. BOX 1022, MINNEAPOLIS, MN, 55440-1022, US

(21) Appl. No.: 11/571,110

(22) PCT Filed: Jun. 21, 2005
(86) PCT No.: PCT/US05/22257

§ 371 Date: Jun. 12, 2007

Related U.S. Application Data
(63) Continuation of application No. 60/582,490, filed on Jun. 24, 2004.

(51) Int. Cl. G07F 9/06

(52) U.S. Cl. 194/350

(57) ABSTRACT

A rotating hinged cashbox for a vending or gaming machine that can be tilted for emptying can include a pivot mechanism that engages corresponding pivot features of the vending or gaming machine. The cashbox can include a cassette having a receptacle for receiving payments deposited into the vending or gaming machine and a pivot point on the cassette that enables the cassette to rotate relative to the vending or gaming machine.

### CROSS-REFERENCE TO RELATED APPLICATIONS

This application is related to and claims the benefit of co-pending U.S. Provisional Application Ser. No. 60/582,490, filed Jun. 24, 2004, which is incorporated herein by reference.

### BACKGROUND

This description relates to vending and gaming machines, and more particularly to removable hinged cashboxes.

Many vending and gaming machines are coin operated. Thus, a consumer may insert a combination of coins and/or bills having a value that equals or exceeds the price of an item to be purchased and selects the item by pushing a button associated with the item. The item is delivered to a dispenser area from which the consumer can retrieve the item. In some cases, change can be returned to the consumer through a coin return.

In large capacity vending machines where the machine may be unattended for some time and in high sales volume locations, the machine often is capable of holding large volumes of coins. Coins are frequently maintained in a cashbox inside the machine, which enables the machine to hold large volumes of coins and facilitates convenient removal of coins from the machine. In particular, the cashbox can be removed from the machine by service personnel and emptied into a cash bag.

### SUMMARY

In one general aspect, a rotating hinged cashbox for a vending machine can be tilted for emptying.

Implementations can include one or more of the following features. The cashbox may be detachable from the vending machine. The cashbox may include a cassette and may have a hinge point located close to an edge of the cassette. The hinge point may be located close to the gravity center of the cashbox so that a weight of the cashbox is substantially balanced as the cashbox is rotated. The hinge point may be located such that a weight of coins in the cashbox tends to maintain the cashbox in a vertical position. A range of rotation of the cashbox may be limited by a stopping mechanism, which can include a peg, a cable, or a rod and which holds the cashbox attached to the vending machine or a safe within the vending machine. The stopping mechanism can be embossed on the vending machine or on a wall of a safe within the vending machine or can be distinct components attached to the vending machine or a wall of a safe within the vending machine. The cashbox may be attached to the vending machine for most of a range of movement, except for a point of exit where the cashbox can be entirely detached from the vending machine or a wall of a safe within the vending machine.

In another general aspect, a cashbox may be mounted in a safe compartment of a vending machine by hinges.

Implementations can include one or more of the following features. Each hinge may include a protrusion and an aperture for engaging the protrusion. The hinges allow the cashbox to rotate relative to the vending machine. The cashbox may be installed in the vending machine and rotated to an upright position. Installing the cashbox in the vending machine may include sliding the cashbox along one or more guides and engaging the protrusions in the apertures. Coins are collected in the cashbox, and the cashbox may be rotated using the hinges to facilitate emptying the cashbox.

In another general aspect, a cashbox may include a cassette that further includes a receptacle for receiving payments deposited into a machine and a pivot point on the cassette. The pivot point enables the cassette to rotate relative to the machine.

Implementations can include one or more of the following features. The pivot point may include a pivot point aperture for engaging a pivot peg, and the pivot point aperture may enable the cassette to rotate relative to the pivot peg. The pivot peg may be a weight-bearing pivot peg. The cashbox may include stop aperture for accepting a stop peg. The stop aperture interacts with the stop peg to limit a range of movement of the cassette. For example, the stop aperture may be an arcuate slot for limiting rotational movement of the cassette relative to the pivot peg. The dimensions of at least a portion of the arcuate slot prevent substantial translational movement of the cassette perpendicular to the pivot peg when the pivot point aperture is engaging the pivot peg, and the dimensions of the arcuate slot enable rotation of the cassette for emptying the receptacle.

The stop aperture includes an opening for allowing translational movement of the cassette relative to the pivot peg to disengage the pivot peg from the pivot point aperture. The pivot point aperture and the stop aperture engage the pivot peg and the stop peg, respectively, to enable rotation of the cassette about the pivot peg. The stop aperture includes a slot to enable the cassette to be detached from the machine. A guide aperture engages a guide peg. The guide aperture enables the cassette to be detached from the machine. The guide peg further serves to prevent the cassette from rotating beyond a predetennined rotational limit when the pivot point aperture is engaging the pivot peg. The cassette includes a surface adjacent to the pivot point aperture for guiding the pivot peg to the pivot point aperture. The pivot point engages a protuberance on a wall of the machine. The machine may be coin-operated and/or accepts tokens.

The invention can be implemented to realize one or more of the following advantageous features. The cashbox in a vending or gaming machine can be emptied without heavy or awkward lifting and without detaching the cashbox. The cashbox can remain relatively balanced during rotation. The cashbox can be installed in a natural and intuitive manner. Rotation and movement of the cashbox can be limited. One implementation of the described cashbox provides all of the above advantages.

The details of one or more implementations are set forth in the accompanying drawings and the description below. Other features will be apparent from the description and drawings, and from the claims.

### DESCRIPTION OF DRAWINGS

FIG. 1 is a front view of an example of a vending machine.

FIG. 2 is an enlarged, cutaway view along dotted line A-A of FIG. 1 which illustrates the layout of certain internal components of the vending machine.

FIG. 3 is a perspective view of a removable hinged cashbox.

FIG. 4 is a side view of the cashbox 300 of FIG. 3 and a side cutaway view of a host machine.

FIG. 5 is a perspective view of the removable hinged cashbox tilted down for emptying.

FIG. 6 is a side view of the removable hinged cashbox tilted down for emptying.

FIG. 7 is a side view of the removable hinged cashbox with another stop mechanism.

FIG. 8 is a side view of the removable hinged cashbox in an installed position.

FIG. 9 is a flow diagram of a process for mounting a cashbox in a safe compartment of a vending machine.

Like reference symbols in the various drawings indicate like elements.

### DETAILED DESCRIPTION

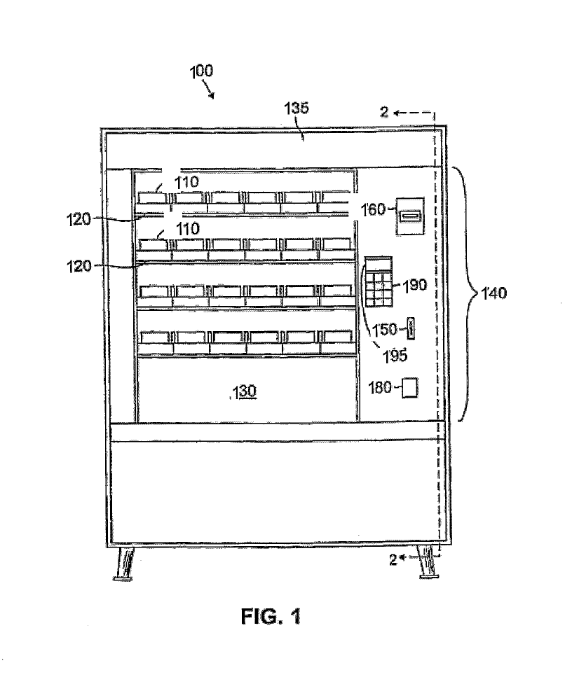

FIG. 1 is a front view of an example of a vending machine 100. As used herein, the term “vending machine” includes any automatic transaction machine that can dispense products or provide services. For example, a variety of products 110 to be dispensed may be stored in a display area inaccessible to customers, such as behind a transparent glass panel, or in another area inaccessible to customers, such as a refrigerated compartment. Each product 110 is retained by a product delivery apparatus 120 that can be selectively actuated by a customer to dispense the product into a delivery area 130 from which the customer can retrieve the selected product.

The front panel 135 of the vending machine 100 includes a control panel 140 having a coin slot 150 and a bill entryway 160. The control panel 140 also includes a coin return 180 and an item selector such as a keypad 190. A display 195 can provide instructions and information to a customer.

A customer may initiate a transaction, for example, by depositing coins or bills of particular denominations into respective openings 150 or 160 along the control panel 140. Once sufficient payment has been deposited, the customer can select a product 110 to be dispensed using the keypad 190. The corresponding product delivery apparatus 120 then dispenses the selected product 110 to the product delivery area 130 where it can be retrieved by the customer. Any change resulting from the transaction can be paid back to the customer through the coin return opening 180.

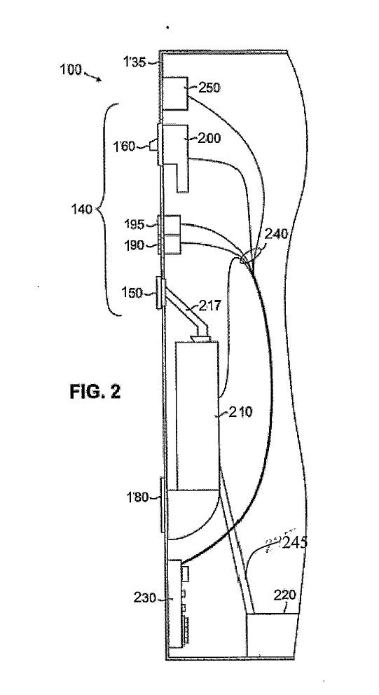

FIG. 2 is an enlarged, cutaway view along dotted line A-A of FIG. 1 which illustrates the layout of certain internal components of the vending machine. In particular, connected to the rear of the control panel 140 are a bill validator-stacker unit 200 aligned with the bill entryway 160 and a coin validator 210 connected to the coin slot 150 via a coin passageway 217. The coin validator 210 is also connected to the coin return 180 and to a coin box or cashbox 220. The keypad 190 and display 195 are also connected to the control panel 140, and are electronically connected by lines 240 to a vending controller 230. The bill validator-stacker unit 200 and the coin validator 210 are also electronically connected to the vending controller 230.

The bill validator-stacker unit 200 and the coin validator 210 detect bills and coins, respectively, that are deposited in the vending machine 100 and electronically communicate values of detected denominations to the vending controller 230 through the lines 240. The vending controller 230 can cause the display 195 to show a total amount deposited, receive electronic signals from the keypad 190 indicating which product is selected by the customer, and, once a sufficient payment is deposited, control an actuation of the corresponding product delivery apparatus 120.

The vending controller 230 can also cause the coin validator 210 to return change, as appropriate, to the customer through the coin return opening 180. Accordingly, the coin validator 210 generally stores multiple coins of each denomination (e.g., nickels, dimes, and quarters) and includes a coin dispenser, which can be selectively actuated to dispense coins into the coin return opening 180. In some implementations, the coins that are stored in the coin validator 210 are replenished as coins are deposited into the coin slot 150. Once the storage for each coin denomination is full, additional coins are delivered to the cashbox 220 through a coin chute 225. In other implementations, coins that are deposited into the coin slot 150 can be delivered to the cashbox 220 through the coin chute 225 without regard to the coin storage within the coin validator 210.

The cashbox 220 can be located anywhere within the vending machine 100. For example, although the cashbox 220 is illustrated as being located a short distance back from the front panel 135 and at the bottom of the vending machine 100, the cashbox 220 can be located just behind the front panel 135 of the vending machine 100 or farther back from the front panel 135 and need not rest on the bottom of the vending machine 100. Similarly, other components of the vending machine 100 can be rearranged, omitted, or included depending on desired design and functional features.

Typically, the cashbox 220 is located substantially under the coin slot 150 and/or the coin validator 210, but, in some implementations, one or more chutes and clearances can be used to redirect coins laterally (e.g., to a cashbox 220 located lower than, but to one side of, the coin validator 210). In addition, the cashbox 220 is generally located such that coins can be delivered to the cashbox 220 through the operation of gravity. In some implementations, however, it is possible to provide mechanisms for delivery of coins other than through gravity. In most cases the location of the cashbox 220 is determined based on a combination of design considerations, such as available space inside the vending machine 100, ease of accessibility to service and restocking personnel, security against tampering and theft, and relative simplicity of the chutes and clearances used to deliver coins to the cashbox 220.

In some implementations, bills from the bill validator-stacker unit 200 can also be delivered to the cashbox 220 through one or more chutes (not shown) and/or using mechanisms for moving bills or groups of bills to a different location within the vending machine 100. For example, once the bill validator-stacker unit 200 becomes sufficiently filled, a conveyor system can be used to deliver a stack of bills to the cashbox 220.

In general, the vending machine 100 includes one or more locks which prevent unauthorized access to and/or removal of internal components from the machine 100. For example, one or more manual or electronically controlled locks 250 may be located on the inside of the front panel 135. To service the vending machine 100, authorized service personnel may require access to inventory or components of the machine 100 located behind the front panel 135. To open the front panel 135 and gain access to the internal components of the machine 100 as well as the product inventory stored in the machine 100 and the bills and coins contained in the machine 100, the locks 250 must be unlocked. In some implementations, the cashbox 220 is located within a safe of the vending machine 100. Thus, the vending machine 100 can have locks 250 that must be unlocked to gain access to the internal components of the machine, and the safe can have one or more additional locks that must be unlocked to gain access to the cashbox 220 inside the safe. Depending on the design of the vending machine 100 (e.g., whether the safe is accessible from the exterior of the machine 100), the safe can be accessible with or without unlocking the locks 250.

In some cases, a cashbox 220 in a vending machine 100 that is designed to hold large volumes of coins may hold more than twenty pounds (lbs) of coins. Because cashboxes 220 are typically emptied into cloth cash bags by lifting them out of the vending machine 100, emptying a relatively fall, and therefore heavy, cashbox 220 can be an awkward and difficult task. To improve the ease of retrieving coins from a vending machine 100, the cashbox 220 can be designed to allow service personnel to tilt the cashbox 220 and pour coins and/or other currency into a cash bag without the need, or with a reduced need, for lifting. In some implementations, the cashbox can be removable and can be designed to be inserted and removed in a manner similar to that of conventional cashboxes.

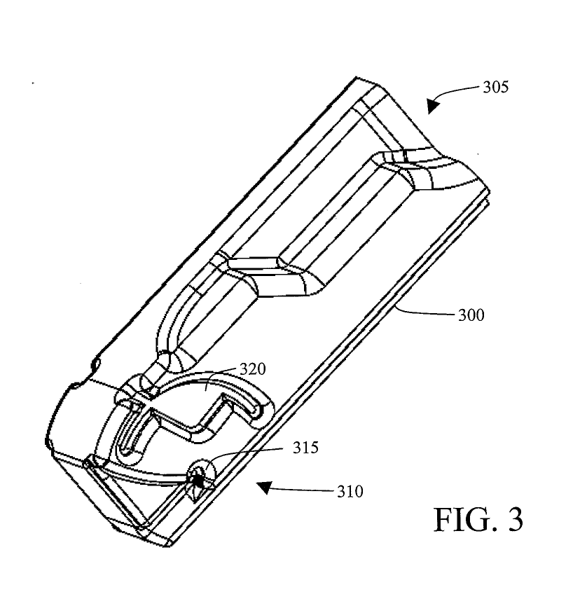

FIG. 3 is a perspective view of a removable hinged cashbox 300. The cashbox 300 defines or is a part of a cassette that can be inserted into a vending machine. The cashbox 300 includes a receptacle 305 for storing coins, other forms of currency, and/or other forms of payment that are inserted into the vending machine. Thus, as used herein, the term “coin” includes any coin (whether genuine or counterfeit), token, slug, washer, or other metallic object that may be used to operate a coin-operated device or system. Coins and other forms of payment can be deposited into the receptacle 305 through an open top or through one or more slots or other openings, which may mate with or otherwise correspond to chutes or openings within the vending machine for delivering coins and other payments to the cashbox 300.

Each side of the cashbox 300 includes a pivot mechanism 310. Each pivot mechanism 310 includes a pivot or hinge point 315 that facilitates rotation of the cashbox 300 and an aperture 320 that facilitates limiting a range of motion of the cashbox 300, enabling the cashbox 300 to be installed and removed from the vending machine, and/or maintaining contact between the hinge point 315 and a corresponding hinge feature (not shown). The pivot mechanism 310 enables the cashbox 300 to be tilted from an upright position to a downward-facing position for emptying without having to lift the cashbox 300 out of the vending machine.

The cashbox 300 can have any shape, length, and depth and generally includes a shape and dimensions corresponding to or appropriate for the vending machine in which the cashbox 300 is to be installed. For example, the cashbox 300 can have a shape that provides appropriate clearances for other components or features adjacent to the cashbox 300 when it is installed in the vending machine. The cashbox 300 can be a one-piece, molded component that is blow molded or rotationally molded and that includes an integrated pivot mechanism 310. Alternatively, the cashbox 300 can be constructed from multiple components and/or the pivot mechanism 310 can be one or more separate components that are attached to the cashbox 300. Similarly, the pivot mechanism 310 can be part of or separate from the cassette. The cashbox 300 and the pivot mechanism 310 can be constructed of any suitable material.

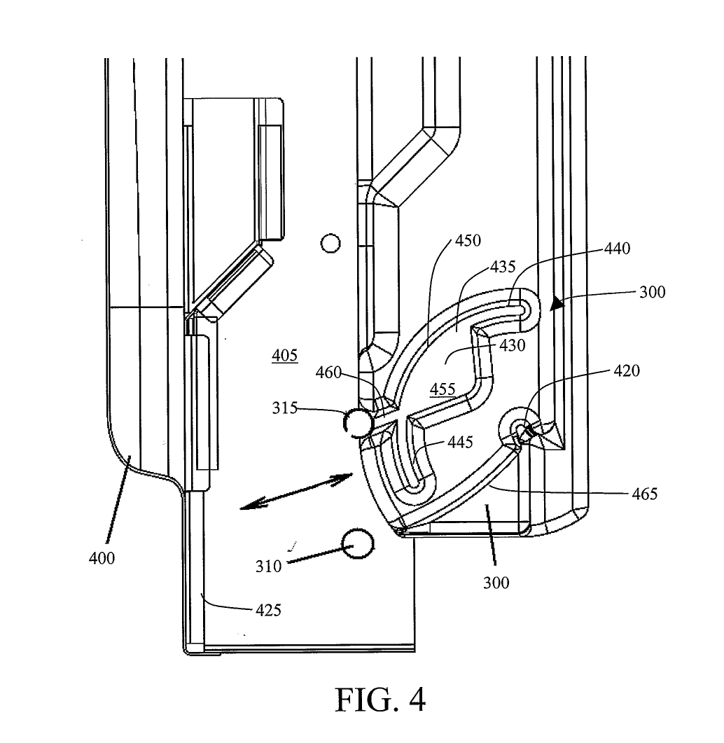

FIG. 4 is a side view of the cashbox 300 of FIG. 3 and a side cutaway view of a host machine 400. The host machine 400 includes a cashbox storage area 405 in which the cashbox 300 can be installed. The cashbox storage area 405 is inside the host machine 400 and is generally within a safe compartment of the host machine 400. The safe compartment can be, for example, an interior of the host machine 400 that is accessible only by opening a door that includes one or more locks. Alternatively or in addition, the safe compartment can include a more conventional safe with reinforced walls and a locking mechanism designed to make tampering or unauthorized access more difficult. The host machine 400 further includes pegs 410 and 415 on each side of the cashbox storage area 405 for engaging pivot mechanisms 310 on the cashbox 300.

The cashbox 300 includes a pivot point aperture 420 that defines a pivot point 315 for the cashbox 300 when the cashbox is installed in the host machine 400. The pivot point aperture 420 is shaped to engage a pivot peg 410 to limit translational movement of the cashbox 300 in most directions perpendicular to an axis of the pivot peg 410. For example, when the pivot point aperture 420 engages the pivot peg 410 with the cashbox 300 in an upright position, the pivot point aperture 420 bears at least some of the weight of the cashbox 300 and substantially prevents the cashbox 300 from moving laterally toward or away from a wall 425 of the host machine 400. The pivot point aperture 420 is open on a lower side to enable the pivot peg 410 to be disengaged from the pivot point aperture 420 by moving the cashbox 300 away from the open side of the pivot point aperture 420 and in a direction perpendicular to the axis of the pivot peg 410.

The cashbox 300 further includes a guide or stop aperture 430 that engages a guide or stop peg 415 in the host machine 400. The stop aperture 430 serves to guide the cashbox 300 into an installed position, to limit the range of rotational movement of the installed cashbox 300, to limit some translational movement of the installed cashbox 300, and to enable the cashbox 300 to be detached from the host machine 400. The stop aperture 430 includes an arcuate portion 435, which includes a first arcuate slot 440, a second arcuate slot 445, and a middle arcuate surface 450. The stop aperture 430 also includes an opening 455 adjacent to the middle arcuate surface 450. The stop aperture 430 also includes an insertion slot 460 that enables the cashbox 300 to be installed in the host machine 400 and detached from the host machine 400. In some implementations, the cashbox 300 is not removable, in which case the insertion slot 460 can be omitted.

Each aperture 420 and 430 can be a recessed area in a side of the cashbox 300, such that a side wall of the cashbox 300 is recessed in the areas covered by the apertures 420 and 430 (see FIG. 3). Thus, each peg 410 and 415 generally projects far enough to engage surfaces of the apertures 420 and 430 that are generally perpendicular to the side walls of the cashbox 300. In some implementations, however, it is possible for the apertures 420 and 430 to extend through the cashbox 300 (e.g., from one side wall to the other), in which case the pegs 410 and 415 can also extend from one side of the cashbox 300 to the other.

The pegs 410 and 415 can be any form of protuberance or protrusion having any shape, including, for example, cylindrical, conical, or tapered and/or can have different widths along a length of the pegs 410 and 415 and can have one or more flat sides. The pegs 410 and 415 can be an integrated part of (e.g., embossed on) sidewalls (not shown) of the host machine 400 or a safe compartment in the host machine 400 or can be separate, add-on components of the host machine 400.

To install the cashbox 300 in the host machine 400, the stop peg 415 is inserted into the insertion slot 460, which guides the cashbox 300 in a direction defined by the insertion slot 460. The insertion slot 460 can be at an angle relative to horizontal (e.g., with horizontal defined, in this case, by the bottom of the cashbox 300), which, in the illustrated example, is about fifteen degrees. The angle of the insertion slot 460 can make installing the cashbox 300 into the host machine 400 more intuitive and can enable gravity to make proper installation more natural.

A guide surface 465 adjacent to the pivot point aperture 420 also facilitates installation by providing a contact surface for the pivot peg 410. The guide surface 465 allows a least some of the weight of the cashbox 300 and any contents to be transferred to the pivot peg 410 during installation and detaching of the cashbox 300 in the host machine 400. In addition, the dimensions of the guide surface 465 relative to the insertion slot 460 and the stop aperture 430 are such that the angle at which the cashbox 300 is installed is limited.

As the cashbox 300 is installed, the stop peg 415 enters the insertion slot 460. The angle and/or dimensions of the insertion slot 460 tend to result in insertion of the cashbox 300 such that the guide surface 465 contacts the pivot peg 410. The pivot peg 410 slides along the guide surface 465 of the cashbox 300 until the cashbox 300 falls into place with the pivot point aperture 420 engaging the pivot peg 410 and the arcuate portion 435 of the stop aperture 430 engaging the stop peg 415. The opening 455 of the stop aperture 430 provides some freedom of movement during installation of the cashbox 300 by allowing the stop peg 415 to “float” within the opening 455.

Once the cashbox 300 is installed, the pivot peg 410 tends to remain engaged by the pivot point aperture 420 and the stop peg 415 tends to remain engaged by the arcuate portion 435 of the stop aperture 430 due to the weight of the cashbox 300 and any contents. In the installed position, the cashbox 300 can be rotated about the pivot peg 410. When the cashbox 300 is in a relatively upright position, the first arcuate slot 440 of the stop aperture 430 engages the stop peg 415 and prevents the cashbox 300 from being lifted off of the pivot peg 410 (e.g., to disengage the pivot point aperture 420 from the pivot peg 410). In other words, the dimensions of the first arcuate slot 440 prevent any substantial translational movement of the cashbox 300 in a direction perpendicular or radial to the pivot peg 410. The terminating end of the first arcuate slot 440 can also serve as a stop to prevent the cashbox 300 from being rotated beyond the upright position.

As the cashbox 300 is rotated to a horizontal or relatively downward-facing position, the second arcuate slot 445 of the stop aperture 430 engages the stop peg 415 and helps prevent the cashbox 300 from being lifted off of the pivot peg 410. The terminating end of the second arcuate slot 445 also serves as a stop to prevent the cashbox 300 from being rotated beyond a predetermined downward-facing position (i.e., to limit a range of rotation of the cashbox). In other words, the dimensions of the second arcuate slot 445 prevent any substantial translational movement of the cashbox 300 in a direction perpendicular or radial to the pivot peg 410, although such movement may also be prevented by a side of the pivot point aperture 420.

The middle arcuate surface 450 of the stop aperture 430 can serve as an additional weight-bearing surface during rotation of the cashbox 300. The opening 455 of the stop aperture 430 facilitates removal or detaching of the cashbox 300 from the host machine 400. In particular, the opening 455 enables the pivot point aperture 420 to be lifted off of and disengaged from the pivot peg 410 by allowing the stop peg 415 to “float” within the opening 455. The lower surface of the opening 455 can define a surface that is at the same angle as the insertion slot 460, which tends to guide the stop peg 415 toward the insertion slot 460 when detaching the cashbox 300 from the host machine 400. By disengaging the pivot point aperture 420 from the pivot peg 410, the cashbox 300 can be removed from the host machine by moving the stop peg 415 through the insertion slot 460.

The pivot point aperture 420 can be located close to an edge of the cashbox 300 and/or close to a center of gravity of the cashbox 300. By locating the pivot point aperture 420 close to an edge rather than in the horizontal center of the cashbox 300, the weight of the cashbox 300 and any contents creates a torque that tends to maintain the cashbox 300 in an upright position inside the host machine 400. In addition, by locating the pivot point aperture 420 at a raised position relative to the bottom of the cashbox 300, the pivot point for the cashbox 300 is located closer to an average center of gravity of the cashbox 300, which can substantially balance the weight of the cashbox 300 as it is rotated and slow down rotation to prevent the cashbox 300 from rapid toppling. Depending on the amount of coins or other contents, the actual center of gravity of the cashbox 300 can change, but the pivot point can be located such that the weight of the cashbox 300 can be substantially balanced for a wide range of different levels of contents.

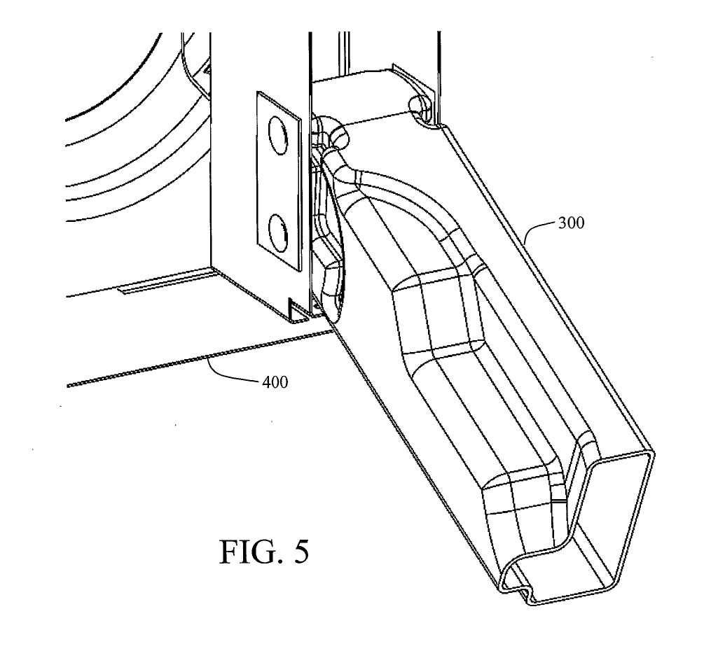

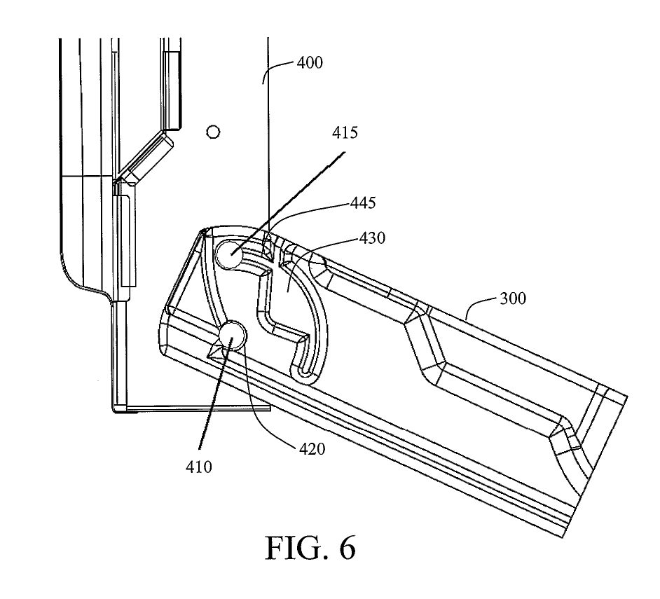

FIG. 5 is a perspective view of the removable hinged cashbox 300 tilted down for emptying. FIG. 6 is a side view of the removable hinged cashbox 300 tilted down for emptying. In the tilted-down position, the cashbox 300 remains attached to the host machine 400 based on the interaction between the pivot peg 410, the stop peg 415, the pivot point aperture 420, and the stop aperture 430. The pivot point aperture 420 remains engaged with the pivot peg 410, and the stop peg 415 abuts an end of the second arcuate slot 445 of the stop aperture 430. The host machine 400, or a safe compartment of the host machine 400, includes sturdy pegs 410 and 415 to support the cashbox 300 when it is in the fully forward, tilted position. The interaction of the stop peg 415 with the end of the second arcuate slot 445 limits the forward and downward range of motion of the cashbox 300. In addition, the stop peg 415 helps hold the cashbox 300 attached to the host machine 400 when the cashbox 300 is tilted because the torque resulting from the cashbox weight and the stop peg 415 tends to maintain the pivot point aperture 420 engaged with the pivot peg 410.

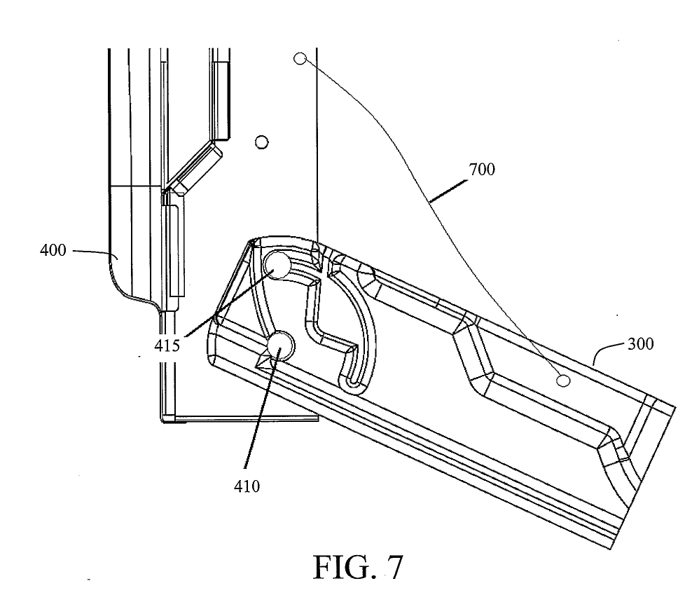

FIG. 7 is a side view of the removable hinged cashbox 300 with another stop mechanism 700. In addition or as an alternative to using the stop peg 415 to limit the range of rotation of the cashbox 300, a cable 700 or a rod can be used. The cable 700 or rod can removably or fixedly attach to the host machine 400 and to the cashbox 300.

In general, the interaction of the pivot mechanism 310 (e.g., the pivot peg 410, the stop peg 415, the pivot point aperture 420, and the stop aperture 430) with corresponding features (e.g., the pegs 410 and 415) of the host machine 400 form a type of hinge for the cashbox 300 to enable the cashbox 300 to be tilted for emptying. In some implementations, other types of hinges can be used to enable tilting of the cashbox 300. In addition, as an alternative implementation to that illustrated, one or more of the pegs 410 and 415 can be attached to the cashbox or cassette and the corresponding apertures 420 and 430 can be located on the host machine 400. For example, the cassette can include a hinge or pivot point that is defined by a pivot peg 410 that is attached to the cassette and that engages a pivot point aperture 420 formed in the host machine 400 or formed in a component attached to the host machine 400.

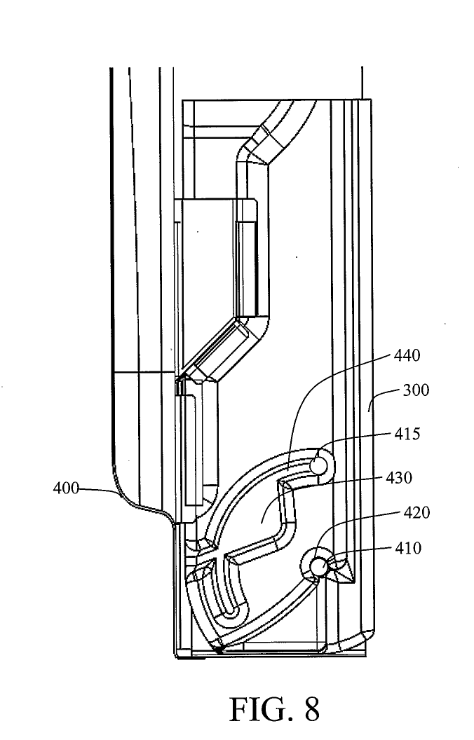

FIG. 8 is a side view of the removable hinged cashbox 300 in an installed position. In the installed position, the pivot point aperture 420 engages the pivot peg 410, and the stop peg 415 abuts an end of the first arcuate slot 440. Otherwise, the cashbox 300 rests inside of the host machine 400.

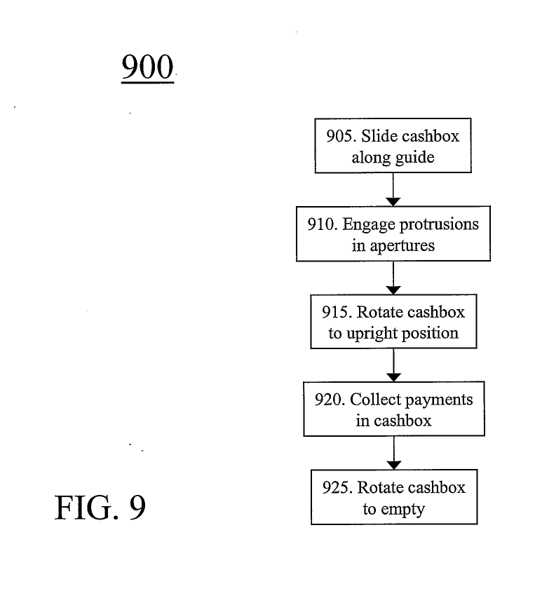

FIG. 9 is a flow diagram of a process 900 for mounting a cashbox in a safe compartment of a vending machine. The cashbox can be mounted using hinges, and the process 900 can use a cashbox 300 and corresponding components of a host machine 400 as described above. The cashbox is installed in the machine by sliding the cashbox along at least one guide (905) and engaging one or more protrusions in one or more corresponding apertures (910). For example, the guide can include the insertion slot 460 and/or the guide surface 465 described above, and the protrusions can include the pegs 410 and/or 415 described above. The cashbox is rotated to an upright or installed position (915). Coins or other forms of payment are collected in the cashbox (920), and the cashbox is rotated using the hinges to facilitate emptying the cashbox (925).

A number of implementations have been described. Nevertheless, it will be understood that various modifications may be made. For example, a rotating hinged cashbox can be used in gaming machines in addition to or instead of vending machines, and the features and mechanisms that enable tilting of the cashbox can be different than those shown. In addition, use of such a cashbox is not limited to the storage of currency in circulation but can also be used in connection with tokens or other predetermined units of trade. Accordingly, other implementations are within the scope of the following claims.

What is claimed is:

1. A rotating hinged cashbox for a vending or gaming machine that can be tilted for emptying.

2. The cashbox of claims 1 wherein the cashbox is detachable from the vending or gaming machine.

3. The cashbox of claim 1 comprising a cassette and having a hinge point located close to an edge of the cassette.

4. The cashbox of claim 3 wherein the hinge point is located close to the gravity center of the cashbox so that a weight of the cashbox is substantially balanced as the cashbox is rotated.

5. The cashbox of claim 3 wherein the hinge point is located such that a weight of coins in the cashbox tends to maintain the cashbox in a vertical position.

6. The cashbox of claim 1 wherein a range of rotation of the cashbox is limited by a stopping means.

7. The cashbox of claim 6 wherein the stopping means comprises at least one of a peg, a cable, or a rod.

8. The cashbox of claim 6 wherein the stopping means holds the cashbox attached to the vending or gaming machine or a safe within the vending or gaming machine.

9. The cashbox of claim 6 wherein the stopping means is embossed on the vending or gaming machine or on a wall of a safe within the vending or gaming machine.

10. The cashbox of claim 6 wherein the stopping means comprises distinct components attached to the vending or gaming machine or a wall of a safe within the vending or gaming machine.

11. The cashbox of claim 1 wherein the cashbox is attached to the vending or gaming machine for most of a range of movement, except for at least one point of exit where the cashbox can be entirely detached from the vending or gaming machine or a wall of a safe within the vending or gaming machine.

12. A method of mounting a cashbox in a safe compartment of a vending or gaming machine by hinges.

13. The method of claim 12 wherein each hinge comprises a protrusion and an aperture for engaging the protrusion, the hinges allowing the cashbox to rotate relative to the vending or gaming machine.

14. The method of claim 13 comprising:
coupling the cashbox to the vending or gaming machine; and
rotating the cashbox to an upright position in the vending or gaming machine.

15. The method of claim 14 wherein coupling the cashbox to the vending or gaming machine comprises:
sliding the cashbox along at least one guide; and
engaging the protrusions in the apertures.

16. The method of claim 15 further comprising:
collecting coins in the cashbox; and
rotating the cashbox using the hinges to facilitate emptying the cashbox.

17. A cashbox comprising:
a cassette including a receptacle for receiving payments deposited into a machine; and
a pivot point on the cassette, the pivot point enabling the cassette to rotate relative to the machine.

18. The cashbox of claim 17 wherein the pivot point comprises a pivot point aperture for engaging a pivot peg, the pivot point aperture enabling the cassette to rotate relative to the pivot peg.

19. The cashbox of claim 18 wherein the pivot peg comprises a weight-bearing pivot peg.

20. The cashbox of claim 19 further comprising a stop aperture for accepting a stop peg, the stop aperture interacting with the stop peg to limit a range of movement of the cassette.

21. The cashbox of claim 20 wherein the stop aperture comprises an arcuate slot for limiting rotational movement of the cassette relative to the pivot peg.

22. The cashbox of claim 21 wherein dimensions of at least a portion of the arcuate slot prevent substantial translational movement of the cassette perpendicular to the pivot peg when the pivot point aperture is engaging the pivot peg.

23. The cashbox of claim 21 wherein dimensions of the arcuate slot enable rotation of the cassette for emptying the receptacle.

24. The cashbox of claim 21 wherein at least a portion of the stop aperture comprises an opening for allowing translational movement of the cassette relative to the pivot peg to disengage the pivot peg from the pivot point aperture.

25. The cashbox of claim 24 wherein:
the pivot point aperture and the stop aperture engage the pivot peg and the stop peg, respectively, to enable rotation of the cassette about the pivot peg; and
the stop aperture includes a slot to enable the cassette to be detached from the machine.

26. The cashbox of claim 19 further comprising a guide aperture for engaging a guide peg, the guide aperture enabling the cassette to be detached from the machine.

27. The cashbox of claim 26 wherein the guide peg further serves to prevent the cassette from rotating beyond at least one predetermined rotational limit when the pivot point aperture is engaging the pivot peg.

28. The cashbox of claim 26 wherein the cassette comprises a surface adjacent to the pivot point aperture for guiding the pivot peg to the pivot point aperture.

29. The cashbox of claim 17 wherein the pivot point engages a protuberance on a wall of the machine.

30. The cashbox of claim 17 wherein the machine is coin-operated.

31. The cashbox of claim 17 wherein the machine accepts tokens.
